(19) United States
(12) Patent Application Publication
(10) Pub. No.: US 2017/0328235 A1
(43) Pub. Date: Nov. 16, 2017

(54) TURBINE NOZZLE ASSEMBLY AND METHOD FOR FORMING TURBINE COMPONENTS

(71) Applicant: General Electric Company, Schenectady, NY (US)

(72) Inventors: Michael Anthony Ruthemeyer, Cincinnati, OH (US); David Alan Frey, West Chester, OH (US)

(21) Appl. No.: 15/155,110

(22) Filed: May 16, 2016

(51) Int. Cl. F01D 25/12; F02C 3/04; F01D 5/12; F01D 9/04

(52) U.S. Cl. CPC F01D 25/12; F01D 9/041; F02C 3/04; F01D 5/12; F05D 2220/32; F05D 2240/35; F05D 2260/221; F05D 2300/6033; F05D 2230/31

(57) ABSTRACT

A turbine nozzle assembly includes an outer band and an inner band positioned radially inward from the outer band, wherein a gas flow path is defined between the outer and inner band. The turbine nozzle assembly further includes a stator vane extending radially inward from the outer band to the inner band through the gas flow path. In addition, the outer band of the turbine nozzle assembly defines a cavity and a first conduit extending from an inlet to the cavity. The outer band further defines a second conduit extending from the cavity to an outlet such that the cavity is in fluid communication with the gas flow path through the second conduit.

### FIELD OF THE INFORMATION

The present subject matter relates generally to a turbine nozzle assembly and a method for forming turbine components for gas turbine engines. More particularly, the present subject matter relates to a turbine nozzle assembly and a method which provides improved cooling features.

### BACKGROUND OF THE INVENTION

A gas turbine engine generally includes, in serial flow order, a compressor section, a combustion section, a turbine section and an exhaust section. In operation, air enters an inlet of the compressor section where one or more axial compressors progressively compress the air until it reaches the combustion section. Fuel is mixed with the compressed air and burned within the combustion section to provide combustion gases. The combustion gases are routed from the combustion section through a hot gas path defined within the turbine section and then exhausted from the turbine section via the exhaust section.

In particular configurations, the turbine section includes, in serial flow, a high pressure (HP) turbine and a low pressure (LP) turbine. The HP turbine and the LP turbine each include various rotatable turbine components such as turbine rotor blades, rotor disks and retainers, and various stationary turbine components such as a turbine nozzle assembly, turbine shrouds and engine frames. The rotatable and the stationary turbine components at least partially define the hot gas path through the turbine section. As the combustion gases flow through the hot gas path, thermal energy is transferred from the combustion gases to the rotatable turbine components and the stationary turbine components.

In some configurations, a turbine nozzle assembly includes a plurality of nozzle segments arranged circumferentially about an aft end of the combustor. The turbine nozzle segments include a plurality of circumferentially-spaced stator vanes coupled between an inner band and an outer band. More specifically, the inner band forms an inner boundary of the hot gas path, and the outer band forms an outer boundary of the hot gas path.

However, the high temperatures experienced by the turbine nozzle assembly during operation of the gas turbine engine stress the turbine nozzle assembly and affect the durability of the turbine nozzle assembly. One particular area of concern in some turbine nozzle assemblies is the aft region of the outer band. If inadequately cooled, the aft region of the outer band may overheat and limit the overall performance of the gas turbine engine. These issues are of increased concern when turbine nozzle assemblies are formed from ceramic matrix composites.

Accordingly, improved turbine nozzle assemblies and methods for forming turbine components are desired. In particular, outer bands of turbine nozzles and methods for forming turbine components which facilitate improved cooling would be advantageous.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a turbine nozzle assembly. The turbine nozzle assembly includes an outer band and an inner band positioned radially inward from the outer band, wherein a gas flow path is defined between the outer and inner band. The turbine nozzle assembly further includes a stator vane extending radially inward from the outer band to the inner band through the gas flow path. In addition, the outer band of the turbine nozzle assembly defines a cavity and a first conduit extending from an inlet to the cavity. The outer band further defines a second conduit extending from the cavity to an outlet such that the cavity is in fluid communication with the gas flow path through the second conduit.

In another aspect, the present subject matter is directed to a gas turbine engine. The gas turbine engine includes a compressor, a combustion section, a turbine section, and a turbine nozzle assembly. The turbine nozzle assembly includes an outer band and an inner band positioned radially inward from the outer band, wherein a gas flow path is defined between the outer and inner band. The turbine nozzle assembly further includes a stator vane extending radially inward from the outer band to the inner band through the gas flow path. In addition, the outer band of the turbine nozzle assembly defines a cavity and a first conduit extending from an inlet to the cavity. The outer band further defines a second conduit extending from the cavity to an outlet such that the cavity is in fluid communication with the gas flow path through the second conduit.

In a further aspect, the present subject matter is directed to a method for forming a ceramic matrix composite turbine component. The method may include laying up a plurality of composite plies such that a cavity is defined therein, and curing the plurality of composite plies to form a cured ceramic matrix composite turbine component. The method may also include drilling a first conduit that extends from an outer surface of the cured ceramic matrix composite turbine component to the cavity. In addition, the method may include drilling a second conduit that extends from an inner surface of the cured ceramic matrix composite turbine component to the cavity.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 is a schematic cross-sectional view of a gas turbine engine in accordance with one embodiment of the present disclosure;

FIG. 2 is an enlarged cross-sectional side view of a high pressure turbine portion of a gas turbine engine in accordance with one embodiment of the present disclosure;

FIG. 3 is a partial sectional side view of an exemplary turbine nozzle assembly that may be used with the gas turbine engine shown in FIG. 1;

FIG. 4 is a plan view of the turbine nozzle depicted in FIG. 3;

FIG. 5 is a cross-sectional view of a formed turbine component in accordance with one embodiment of the present disclosure;

FIG. 6 is a flow chart illustrating a method for forming a turbine component in accordance with one embodiment of the present disclosure;

FIG. 7 is a cross-sectional view of a formed turbine component in accordance with a second embodiment of the present disclosure;

FIG. 8 is a cross-sectional view of a formed turbine component in accordance with the present disclosure;

FIG. 9 is a flow chart illustrating a method for forming the turbine component of FIG. 8;

FIG. 10 is a flow chart illustrating a method for forming a turbine component; and

FIG. 11 is a cross-sectional view of a turbine component formed from the method of FIG. 10.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Further, as used herein, the terms “axial” or “axially” refer to a dimension along a longitudinal axis of an engine. The term “forward” used in conjunction with “axial” or “axially” refers to a direction toward the engine inlet, or a component being relatively closer to the engine inlet as compared to another component. The term “rear” used in conjunction with “axial” or “axially” refers to a direction toward the engine nozzle, or a component being relatively closer to the engine nozzle as compared to another component. The terms “radial” or “radially” refer to a dimension extending between a center longitudinal axis of the engine and an outer engine circumference.

In general, the present subject matter is directed to a turbine nozzle assembly and methods which provide improved cooling features. Specifically, in several embodiments, the turbine nozzle assembly may include an outer band defining a cavity positioned between an inner and outer surface of the outer band. As will be described below, an inlet may be formed on the outer surface the outer band, and a first conduit may extend from the inlet to the cavity in order to provide a path for fluid (e.g., bleed air) to enter the cavity. Further, an outlet may be formed on the inner surface of the outer band, and a second conduit may extend from the cavity to the outlet in order to provide a path for fluid to exit the cavity. Collectively, the first conduit, cavity, and second conduit define a flow path through the outer band. In one embodiment, bleed air from an upstream component (e.g., compressor) may be routed through the flow path to cool the outer band. In another embodiment, bleed air may be routed through the flow path to cool other downstream components (e.g., shrouds).

It should be appreciated that the disclosed turbine nozzle assembly and method may generally be used to improve cooling within all types of turbomachinery, including turboprops, turboshafts, turbojets, industrial and marine gas turbine engines, and auxiliary power units.

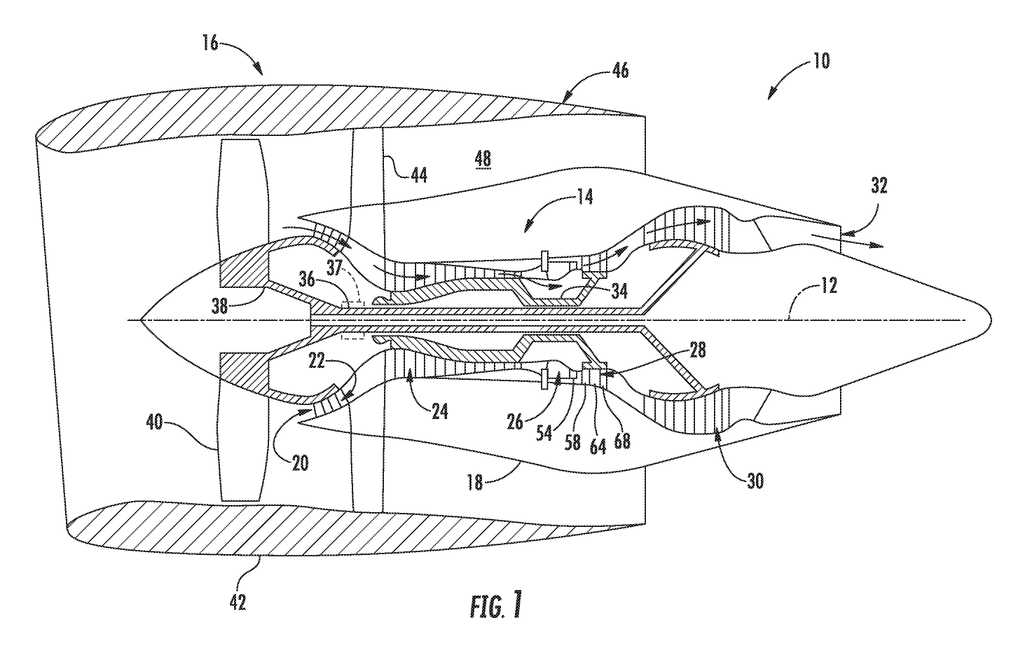

Referring now to the drawings, FIG. 1 is a schematic cross-sectional view of an exemplary high-bypass turbofan type engine 10 herein referred to as “turbofan 10” as may incorporate various embodiments of the present disclosure. As shown in FIG. 1, the turbofan 10 has a longitudinal or axial centerline axis 12 that extends therethrough for reference purposes. In general, the turbofan 10 may include a core turbine or gas turbine engine 14 disposed downstream from a fan section 16.

The gas turbine engine 14 may generally include a substantially tubular outer casing 18 that defines an annular inlet 20. The outer casing 18 may be formed from multiple casings. The outer casing 18 encases, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30, and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the LP compressor 22. The LP spool 36 may also be connected to a fan spool or shaft 38 of the fan section 16. In alternative configurations, the LP spool 36 may be connected to the fan spool 38 via a speed reduction device 37 such as a reduction gear gearbox in an indirect-drive or geared-drive configuration. Such speed reduction devices may be included between any suitable shafts/spools within turbofan 10 as desired or required.

As shown in FIG. 1, the fan section 16 includes a plurality of fan blades 40 that are coupled to and that extend radially outwardly from the fan spool 38. An annular fan casing or nacelle 42 circumferentially surrounds the fan section 16 and/or at least a portion of the gas turbine engine 14. It should be appreciated by those of ordinary skill in the art that the nacelle 42 may be configured to be supported relative to the gas turbine engine 14 by a plurality of circumferentially-spaced outlet guide vanes 44. Moreover, a downstream section 46 of the nacelle 42 (downstream of the guide vanes 44) may extend over an outer portion of the gas turbine engine 14 so as to define a bypass airflow passage 48 therebetween.

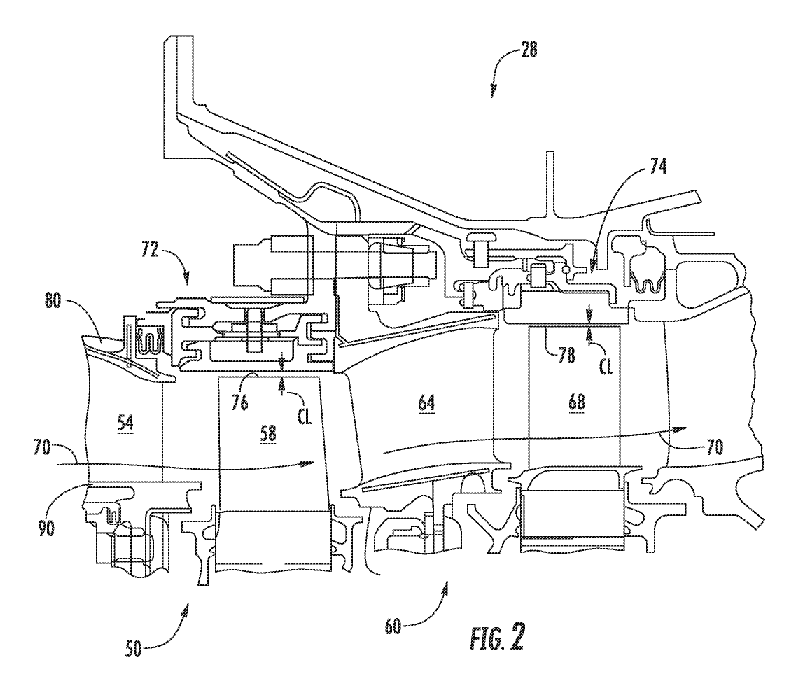

FIG. 2 provides an enlarged cross-sectional view of the HP turbine 28 portion of the gas turbine engine 14 as shown in FIG. 1, as may incorporate various embodiments of the present invention. As shown in FIG. 2, the HP turbine 28 includes, in serial flow relationship, a first stage 50 which includes an annular array of stator vanes 54 (only one shown) axially spaced from an annular array of turbine rotor blades 58 (only one shown). The HP turbine 28 further includes a second stage 60 which includes an annular array of stator vanes 64 (only one shown) axially spaced from an annular array of turbine rotor blades 68 (only one shown). The turbine rotor blades 58, 68 at least partially define a hot gas path 70 for routing combustion gases from the combustion section 26 (FIG. 1) through the HP turbine 28.

As further shown in FIG. 2, the HP turbine 28 may include one or more shroud assemblies, each of which forms an annular ring about an annular array of rotor blades. For example, a shroud assembly 72 may form an annular ring around the annular array of rotor blades 58 of the first stage 50, and a shroud assembly 74 may form an annular ring around the annular array of turbine rotor blades 68 of the second stage 60. In general, shrouds of the shroud assemblies 72, 74 are radially spaced from blade tips 76, 78 of each of the rotor blades 68. A radial or clearance gap CL is defined between the blade tips 76, 78 and the shrouds. The shrouds and shroud assemblies generally reduce leakage from the hot gas path 70.

It should be noted that shrouds and shroud assemblies may additionally be utilized in a similar manner in the low pressure compressor 22, high pressure compressor 24, and/or low pressure turbine 30. Accordingly, shrouds and shroud assemblies as disclosed herein are not limited to use in HP turbines, and rather may be utilized in any suitable section of a gas turbine engine 14.

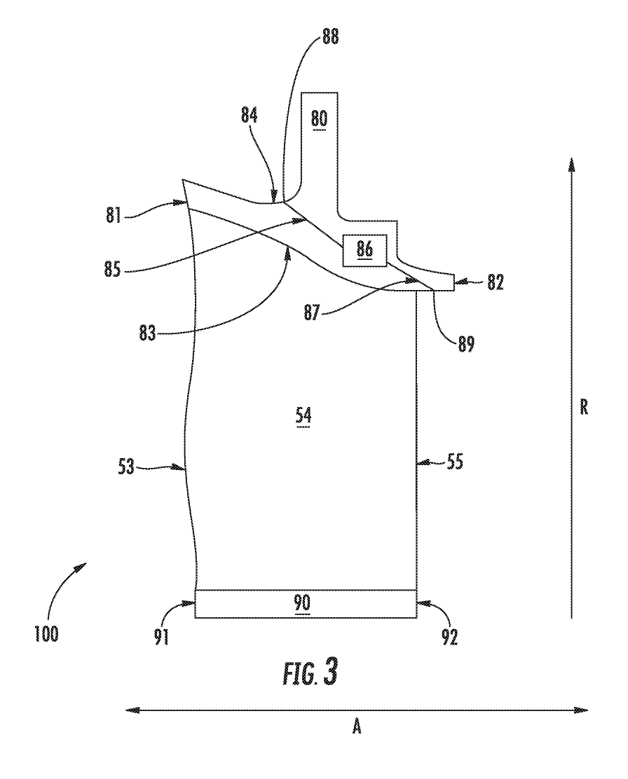

FIG. 3 shows a partial sectional side view of a turbine nozzle assembly 100 that may be used with the gas turbine engine 14 shown in FIG. 1. The turbine nozzle assembly 100 may generally be defined by an annular flow channel that includes a plurality of radially-extending, circularly spaced stator vanes 54 (one of which is shown). Each stator vane 54 may be supported between an outer band 80 and inner band 90 of the turbine nozzle assembly 100. Further, each stator vane 54 includes a leading edge 53 and a trailing edge 55. Likewise, the outer band 80 and inner band 90 each include a leading edge 81 and 91, respectively, and a trailing edge 82 and 92, respectively. The stator vane(s) 54 are oriented such that the outer band leading edge 81 and inner band leading edge 91 are upstream from the stator vane leading edge 53 to facilitate the outer band 80 and inner band 90 preventing hot gas injections along the stator vane leading edge 54. In some embodiments, the outer band 80 and inner band 90 are each integrally formed with the stator vane 54.

As shown, the outer band 80 of the turbine nozzle assembly 100 includes an outer surface 83 and an inner surface 84. In exemplary embodiments, the inner surface 84 is spaced inward from the outer surface 83 along a radial direction R. Further, the outer band 80 defines a cavity 86 positioned between the inner surface 84 and outer surface 83. In order to provide a flow path for fluid (e.g., bleed air) to enter the cavity 86, a first conduit 85 extends from an inlet 88 to the cavity 86. In addition, a second conduit 87 extends from the cavity 86 to an outlet 89 such that the cavity 86, specifically fluid within the cavity 86, is in fluid communication with the hot gas path 70 depicted in FIG. 2. In exemplary embodiments, the outlet 89 is positioned behind the trailing edge 55 of the stator vane 54 along an axial direction A. Further, in such embodiments the inlet 88 is formed on the outer surface 83 of the outer band 80, and the outlet 89 is formed on the inner surface 84 of the outer band 80.

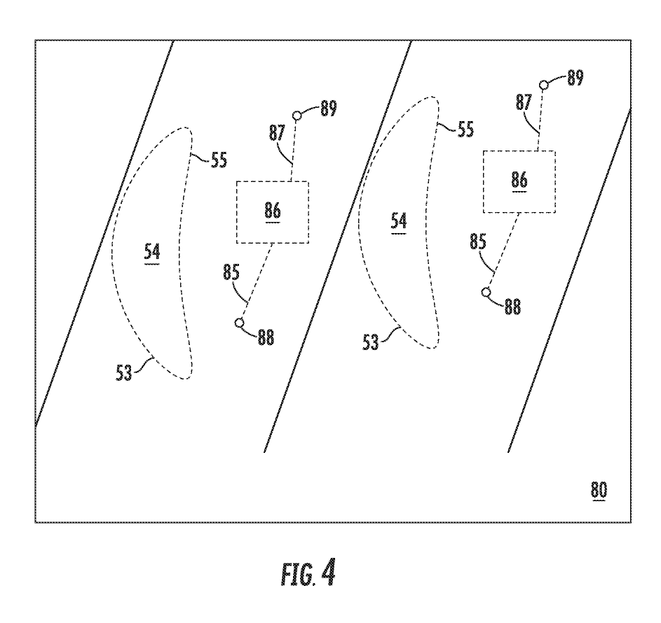

FIG. 4 shows a plan view of the turbine nozzle assembly 100 depicted in FIG. 3. As shown, the turbine nozzle assembly 100 includes two stator vanes 54, and each stator vane 54 extends between the outer band 80 and the inner band (not shown) of the turbine nozzle assembly 100. The first conduit 85 extends from an inlet 88 to the cavity 86, and provides a flow path for fluid to enter the cavity 86. The second conduit 87 extends from the cavity 86 to an outlet 89 that is, in exemplary embodiments, positioned behind the trailing edge 55 of the stator vane 54 along the axial direction A. Collectively, first conduit 85, cavity 86, and second conduit 87 provide a flow path through which a fluid may be routed. In exemplary embodiments, the fluid is bleed air from an upstream component (e.g., compressor) and is used to cool the outer band 80 of the turbine nozzle assembly 100. In another embodiment, the fluid may be used to cool other downstream components such as, without limitation, shroud 72 shown in FIG. 1.

The cross-sectional area of the inlet 88 may, in some embodiments, be equal to the cross-sectional area of the outlet 89. In another embodiment, the first conduit 84 may be linearly defined between the inlet 88 and a first point on the cavity 86 along the axial direction. Further, the second conduit 87 may be linearly defined between a second point on the cavity 86 and the outlet 89 along the axial direction. Still further, the first point on the cavity 86 is, along the axial direction A, non-collinear relative to the second point on the cavity 86.

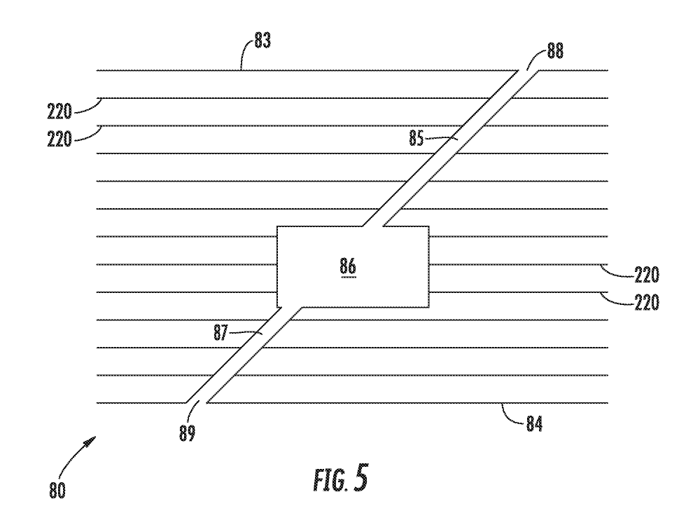

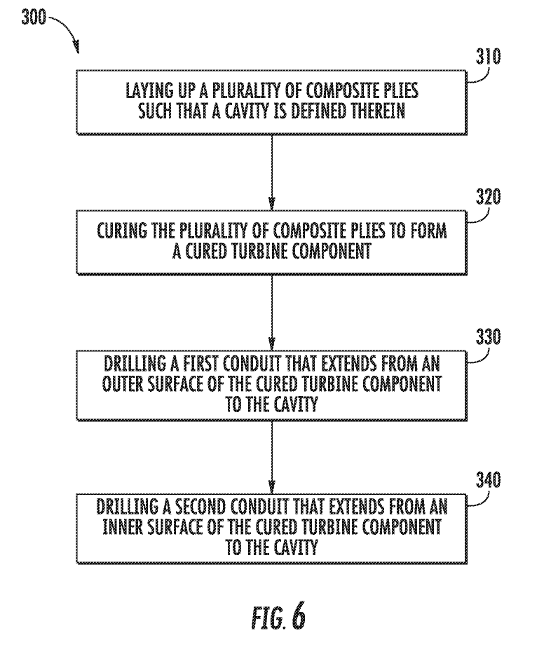

Referring now to FIGS. 5 and 6, the present disclosure may further be directed to a method 300 for forming turbine components for gas turbine engines 14. In some embodiments, a turbine component in accordance with the present disclosure may be an outer band 80 of a turbine nozzle assembly 100. It should be understood, however, that turbine components in accordance with the present disclosure are not limited to outer bands 80, and rather may include any suitable components in a gas turbine engine 14 which require cooling passages to be formed therein.

Method 300 may include, for example, the step 310 of laying up a plurality of composite plies 220 such that the cavity 86 is defined therein. As discussed, the outer band 80 is, in exemplary embodiments, formed from a ceramic matrix composite (“CMC”) material. Referring now to FIG. 5, the outer band 80 may be formed from a plurality of ceramic matrix composite plies 220. Each ply 22 may in some embodiments include fibers, such as ceramic fibers, embedded in a ceramic matrix. The fibers may be continuous fibers (extending through an entire length of the ply) or discontinuous fibers (extending through only a portion of a length of the ply).

Method 300 may further include, for example, the step 330 of drilling the first conduit 85 that extends from the outer surface 83 of the cured turbine component (e.g., outer band of turbine nozzle) to the cavity 86. Method 300 may also include, for example, the step 340 of drilling a second conduit 87 that extends from an inner surface 84 of the cured turbine component to the cavity 86. More specifically, the outer surface 83 may define the inlet 88 that the first conduit 85 extends from to the cavity 86. Likewise, the inner surface 84 may define the outlet 89 that the second conduit 87 extends to from the cavity 86. Accordingly, the cured turbine component may define a path through which fluid (e.g., bleed air) may be routed to cool the cured turbine component or other downstream components of the gas turbine engine 14.

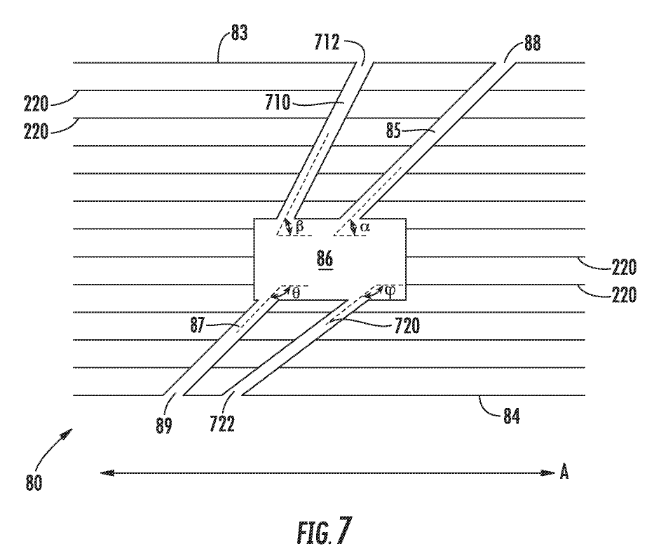

Method 300 may also include additional steps in which additional conduits are drilled. More specifically, as shown in FIG. 7, a third conduit 710 and a fourth conduit 720 may be drilled. Third conduit 710 may extend from the outer surface 83 of the cured turbine component to the cavity 86. Fourth conduit 720 may extend from the cavity 86 to the inner surface 84. Further, the outer surface 83 of the cured turbine component may define an inlet 712 that the third conduit 710 extends from to the cavity 86. Likewise, the inner surface 84 of the cured turbine component may define an outlet 722 that the fourth conduit 720 extends to from the cavity 86.

As shown in FIG. 7, fluid entering the cavity 86 through the first conduit 85 may enter the cavity 86 at an angle a relative to an axial direction A. In contrast, fluid entering cavity 86 through the third conduit 710 may enter the cavity 86 at an angle β relative to axial direction A. It is understood that, in some embodiments, α and β may not be equal to one another. Further, fluid exiting the cavity 86 through the second conduit 87 may exit the cavity 86 at an angle 0 relative to axial direction A. In contrast, fluid exiting the cavity 86 through fourth conduit 720 may exit the cavity 86 at an angle φ relative to axial direction A. It is understood that, in some embodiments, θ and φ may not be equal to one another.

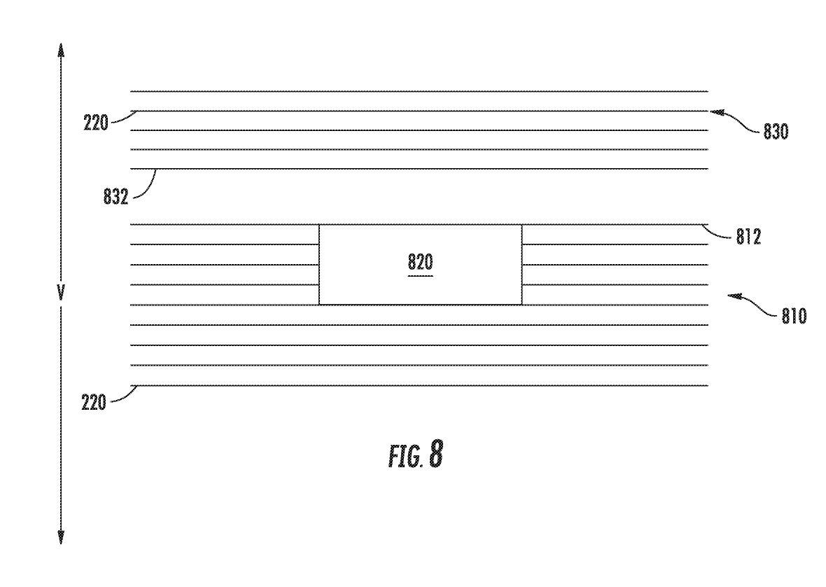

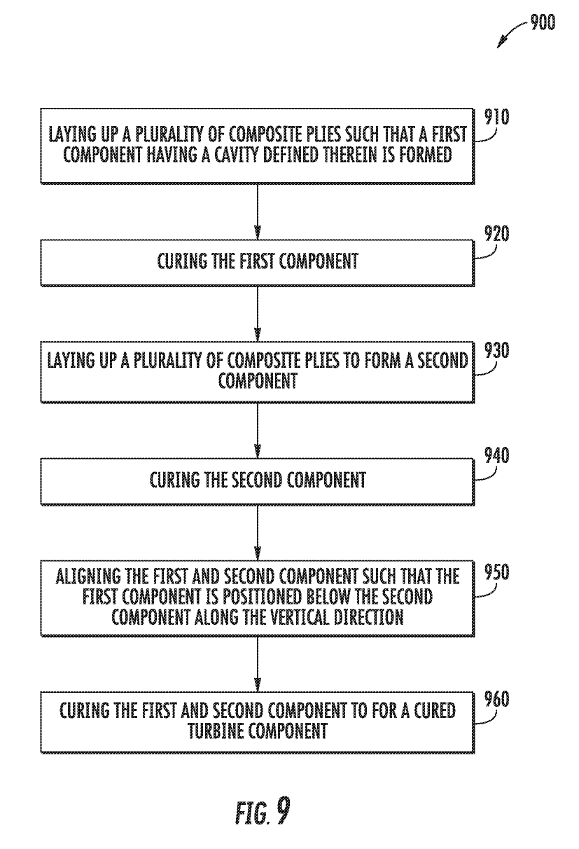

Referring now to FIGS. 8 and 9, another method 900 for forming cured turbine components for gas turbine engines 14 is provided. Method 900 may include, for example, the step 910 of laying up a plurality of composite plies 220 such that a first component 810 having a cavity 820 defined therein is formed. Method 900 may also include the step 920 of curing the first component 810. Further, method 900 may include the step 930 of laying up a plurality of composite plies 220 to form a second component 830. At step 940 of method 900, the second component 830 may be cured.

Method 900 may also include the step 950 of aligning the first and second component 810 and 830 such that the first component 810 is positioned below the second component 830 along the vertical direction V. More specifically, a bottom surface 832 of the second component 830 is positioned such that the bottom surface 832 rests upon a top surface 812 of first component 810. At step 960, first and second component 810 and 830 are cured to form a cured turbine component having a cavity 820 defined therein. Also, although not shown, method 900 may include additional step similar to steps 330 and 340 of method 300 in which first and second conduits are drilled in the cured turbine component to provide a pathway for a fluid to enter and exit the cavity 820.

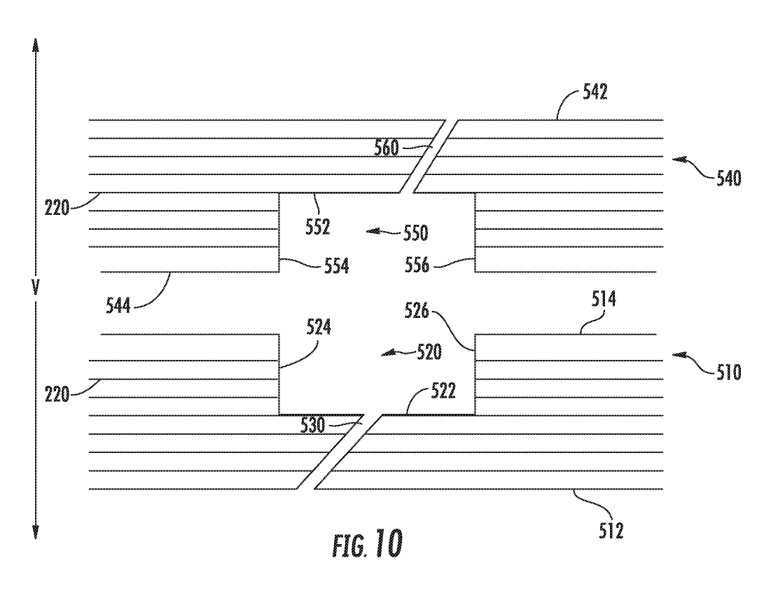

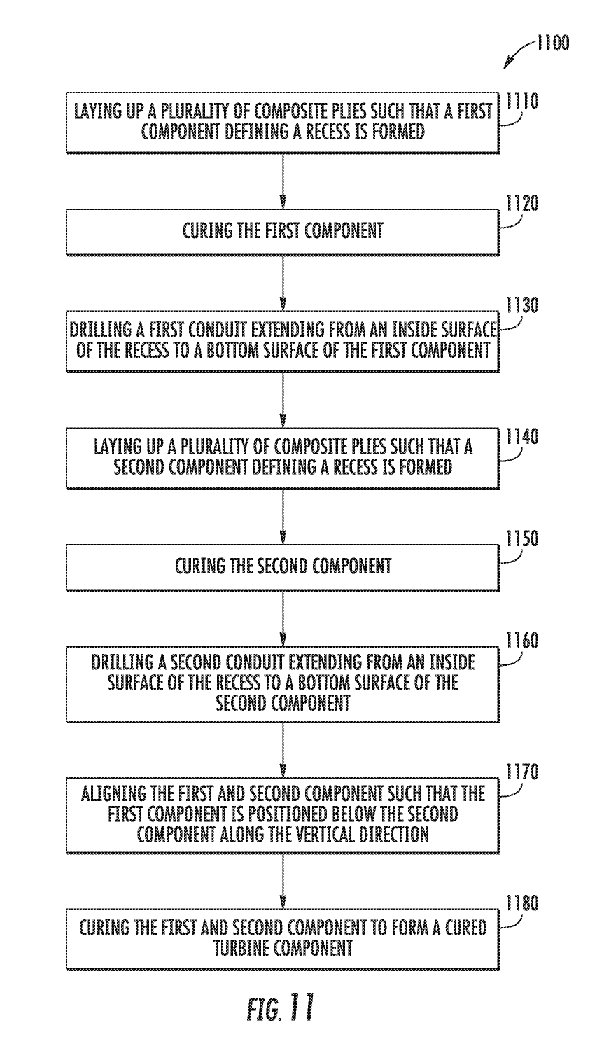

Referring now to FIGS. 10 and 11, yet another method 1100 for forming cured turbine components for gas turbine engines 14 is provided. Method 1100 may include, for example, the step 1110 of laying up a plurality of composite plies 220 to form a first component 510 defining a recess 520. Method 1100 may also include the step 1120 of curing the first component 510. Further, method 1100 may include the step 1130 of drilling a first conduit 530 that extends from an inside surface 522 of the recess 520 to a bottom surface 512 of the first component 510.

At step 1140 of method 1100, one or more composite plies 220 are laid up to form a second component 540 defining a recess 550. The second component 540 is then cured at step 1150. Method 1100 may also include the step 1160 of drilling a second conduit 560 that extends from an inside surface 552 of the recess 550 to a top surface 542 of the second component 540.

At step 1170, the first and second component 510 and 540 are aligned such the first component 510 is positioned below the second component 540 along the vertical direction V. More specifically, a bottom surface 544 of the second component 540 is positioned such that the bottom surface 544 rests upon a top surface 514 of first component 510. Further, the first and second components 510 and 540 are aligned along the vertical direction V such that side walls 524 and 526 of recess 520 are aligned with side walls 554 and 556 of recess 550.

At step 1180, the first and second components 510 and 540 are cured to form a turbine component having a cavity defined therein. More specifically, a top portion of the cavity is defined by recess 550 of the second component 540, and a bottom portion of the cavity is defined by recess 520 of the first component 510.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A turbine nozzle assembly, comprising:
an outer band defining a cavity;
an inner band positioned radially inward from the outer band, wherein a gas flow path is defined between the outer band and the inner band; and
a stator vane extending radially inward from the outer band to the inner band through the gas flow path;
wherein the outer band defines a first conduit extending from an inlet to the cavity;
wherein the outer band defines a second conduit extending from the cavity to an outlet such that the cavity is in fluid communication with the gas flow path through the second conduit.

2. The turbine nozzle assembly of claim 1, wherein the outer band includes a radially inner surface and a radially outer surface, and wherein the cavity is positioned between the radially inner surface and the radially outer surface.

3. The turbine nozzle assembly of claim 2, wherein the radially outer surface defines the inlet.

4. The turbine nozzle assembly of claim 2, wherein the inner radial surface defines the outlet.

5. The turbine nozzle assembly of claim 1, wherein the outer band is constructed from a ceramic matrix composite.

6. The turbine nozzle assembly of claim 1, wherein the first conduit is non-collinear relative to the second conduit.

7. The turbine nozzle assembly of claim 1, wherein the first conduit is linearly defined between the inlet and a first point on the cavity.

8. The turbine nozzle assembly of claim 7, wherein the second conduit is linearly defined between the outlet and a second point on the cavity.

9. The turbine nozzle assembly of claim 8, wherein the first point is non-collinear relative to the second point.

10. The turbine nozzle assembly of claim 1, wherein cross-sectional area of the inlet is equal to cross-sectional area of the outlet.

11. The turbine nozzle assembly of claim 1, wherein the stator vane defines an airfoil having a leading edge and a trailing edge.

12. The turbine nozzle assembly of claim 11, wherein the outlet is positioned behind the trailing edge of the stator vane.

13. A gas turbine engine, comprising:
a compressor;
a combustion section;
a turbine section; and
a turbine nozzle assembly disposed in the turbine section, the turbine nozzle assembly comprising:
an outer band defining a cavity;
an inner band positioned radially inward from the outer band, wherein a gas flow path is defined between the outer band and the inner band; and
a stator vane extending radially inward from the outer band to the inner band through the gas flow path;
wherein the outer band defines a first conduit extending from an inlet to the cavity;
wherein the outer band defines a second conduit extending from the cavity to an outlet such that the cavity is in fluid communication with the gas flow path through the second conduit.

14. The gas turbine engine of claim 13, wherein the outer band of the turbine nozzle includes a radially inner surface and a radially outer surface, and wherein the cavity is positioned between the radially inner surface and the radially outer surface.

15. The gas turbine engine of claim 13, wherein the outer band is constructed from a ceramic matrix composite.

16. A method for forming a ceramic matrix composite turbine component, the method comprising:
laying up a plurality of composite plies such that a cavity is defined therein;
curing the plurality of composite plies to form a cured ceramic matrix composite turbine component;
drilling a first conduit that extends from an outer surface of the cured ceramic matrix composite turbine component to the cavity; and
drilling a second conduit that extends from an inner surface of the cured ceramic matrix composite turbine component to the cavity.

17. The method of claim 16, wherein the turbine component is an outer band of a turbine nozzle assembly.

18. The method of claim 16, wherein the first conduit forms a first angle relative to an axial direction of the cured turbine component, and wherein the second conduit forms a second angle relative to the axial direction.

19. The method of claim 18, wherein the first angle is not equal to the second angle.
